(19) United States
(12) Patent Application Publication
(10) Pub. No.: US 2024/0359587 A1
(43) Pub. Date: Oct. 31, 2024

(54) Protective Device for a High-Voltage Battery in Electrified Motor Vehicles

(71) Applicant: Bayerische Motoren Werke Aktiengesellschaft, Muenchen (DE)

(72) Inventors: Christian KARGES, Muenchen (DE); Franz SCHWINGHAMMER, Muenchen (DE); Lukas WOLF, Muenchen (DE)

(21) Appl. No.: 18/681,541

(22) PCT Filed: Sep. 22, 2022
(86) PCT No.: PCT/EP2022/076380

§ 371 Date: Feb. 6, 2024

(30) Foreign Application Priority Data
Oct. 21, 2021 (DE) 10 2021 127 371.4

(51) Int. Cl. B60L 53/68; B60L 58/13

(52) U.S. Cl. CPC B60L 53/68; B60L 58/13; B60L 2250/12; B60L 2260/22; B60L 2260/58

(57) ABSTRACT

A protective device for a high-voltage battery in an electrified motor vehicle including a charging connection, a terminal, and an electronic control unit. The electronic control unit is connected to an on-board function module configured to locate the motor vehicle and is wirelessly connected to a mobile terminal of a user of the vehicle. The terminal has a function module for locating the user. The electronic control unit is configured to receive data of the mobile terminal, which data represent at least a distance of the user from the motor vehicle when this distance is greater than a predefined limit value.

### BACKGROUND AND SUMMARY

The disclosure proceeds from the knowledge that the batteries of electric vehicles age to a significant degree when they have a high state of charge for a long time. The term “battery” for an electrical energy source in a drive of electrified motor vehicles (for example hybrid vehicles or pure electric vehicles) is also used here for short for a high-voltage storage device or a traction storage battery.

In electric vehicles, use is predominantly made of lithium-ion batteries, which are subject to physical aging. A distinction is made between calendrical and cyclic ageing, wherein the aging is greater, the higher the state of charge in storage and the temperature of the high-voltage storage device.

High-voltage storage devices are usually fully charged where possible, provided a charging cable is plugged in and the vehicle user sets a state of charge of 100% as the charging target. According to the prior art, full charging is generally carried out without the intelligent prediction of when the vehicle is expected to be started up again, except when a manual input device makes it possible for the user to program the specific time for starting up again. If an electric vehicle remains plugged in for a relatively long time and is not moved, the battery ages to an unnecessarily significant degree, in particular in the case of an absence for several weeks (vacation, business trip, etc.), for example.

Battery ages to a significantly lower degree at a state of charge of at most approximately 80%. One possible method for reducing wear in this respect is known, for example, from DE 10 2019 119 761 A1. The method known from this document focuses on several state of charge limit values.

One object of the disclosure to further reduce the aging of a battery in a simple and reliable manner in order to avoid having to change the batteries early for reasons of increased sustainability and reduced costs.

This and other objects are achieved by the features of the description. Further advantageous refinements of the disclosure are also the subject matter of the disclosure.

The disclosure relates to a protective device for a high-voltage battery in an electrified motor vehicle, having a charging connection for charging the high-voltage battery via an energy network which is external to the vehicle, and having an electronic control unit which is designed such that, when the motor vehicle is parked, the control unit monitors and controls the state of charge of the high-voltage battery during charging via the energy network which is external to the vehicle, wherein the control unit is connected to an on-board function module for locating the motor vehicle and is wirelessly connected to a mobile terminal of a user of the vehicle, wherein the terminal has a function module for locating the user and wherein the control unit is configured to receive data of the mobile terminal, which data represent at least the distance of the user from the motor vehicle if this distance is greater than a predefined limit value.

If there are multiple users of the vehicle, a “user” can also preferably include a main user.

The disclosure proposes reading various criteria into an electronic control unit (for example as a “shy tech” function) in order to be able to ensure an intelligent prediction of the use—in particular the next start-up. When a longer stationary time (for example longer than 2 days) is predicted, the state of charge of the high-voltage storage device is reduced to a predefined limit value. This prediction is carried out according to the disclosure by determining the distance of the vehicle user from the vehicle.

The limit value of the battery state of charge is preferably 80%. If this limit value is exceeded, the aging of a lithium-ion battery increases exponentially as the state of charge increases. In principle, the following criteria are proposed for deciding to reduce the state of charge to the predefined limit value:
Battery state of charge is greater than the limit value (for example 80%).
Vehicle stasis is longer than a predefined period of time (for example 2 days).
The distance of the user from the vehicle is greater than a defined distance threshold value (for example 500 km). The distance is determined by means of a mobile terminal (for example a smart phone) carried by the user and having a correspondingly programmed function module (for example having an app), that is to say an application with location both of the vehicle and the user.
Additionally, a comparison with a calendar entry of the user for an appointment with location details can be carried out for correspondingly larger distances.

Based on these criteria, it is possible to derive that the user themself is not going to move the vehicle in the near future. Therefore, a high electrical range or a high state of charge of the battery is not required in the short term.

It is likewise possible to provide a recognition that other people (“joint users”, for example members of the household) will not use the vehicle either. For example, a main user and several joint users can be defined, wherein only the main user can give the approval to reduce the state of charge. The joint users are preferably only informed about the decreasing of the state of charge, for example likewise via the application of a mobile terminal or via an information display in the vehicle. As an alternative or in addition, the joint users can be offered a subfunction using which the decreasing of the state of charge approved originally by the main user can be deactivated again. This subfunction can also be implemented, for example, via the application of a mobile terminal or via a human-machine interface (HMI) in the vehicle.

If the mentioned criteria are present, at least two scenarios are proposed for manual presetting in order to reduce the state of charge a high-voltage storage device in storage to the predefined limit value:

1. Presetting 1: the user approval for decreasing the state of charge to the predefined limit value is requested by means of the mobile terminal each time when the distance of the user from the vehicle exceeds a predefined limit value or when the distance has exceeded the predefined limit value at least for a predefined period of time. The vehicle user or vehicle owner can then decide themself, as necessary, whether they agree to reduce the state of charge in storage.

2. Presetting 2: alternatively, by way of a different corresponding presetting selected by the user or owner of the vehicle, it is possible to automatically decrease the state of charge without further requesting approval each time when the distance exceeds the predefined limit value or when the distance is exceeded the predefined limit value at least for a predefined period of time.

In a preferred refinement of the disclosure, the energy drawn from the high-voltage storage device is used to cool the high-voltage storage device. This can be carried out in several cooling cycles spread out over several days. In addition, this can be done in combination with weather forecasts depending on the ambient temperature. Therefore, the temperature of the high-voltage storage device is also kept lower on hot summer days in order to achieve an additional positive effect on the lifetime of the high-voltage storage device.

The drawing illustrates an exemplary embodiment of the disclosure, in which:

### BRIEF DESCRIPTION OF THE DRAWINGS

FIG. 1 shows a first user scenario according to the disclosure, and

FIG. 2 shows a second user scenario according to the disclosure.

### DETAILED DESCRIPTION OF THE DRAWINGS

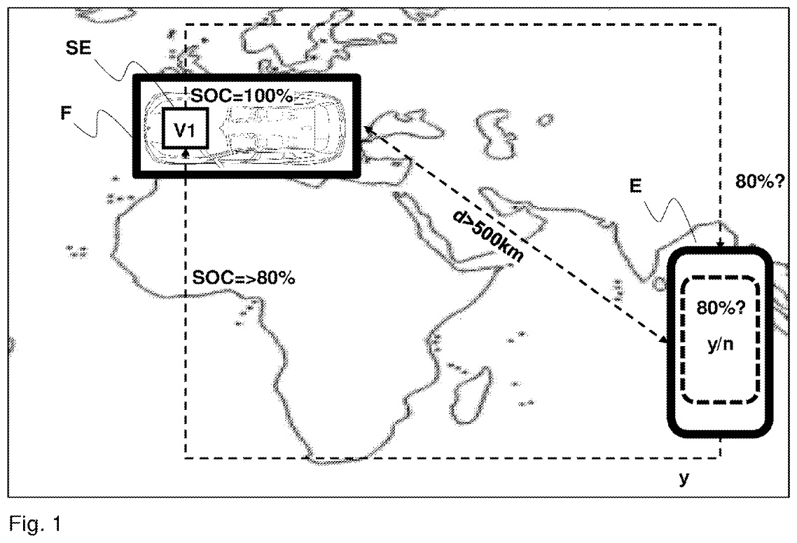

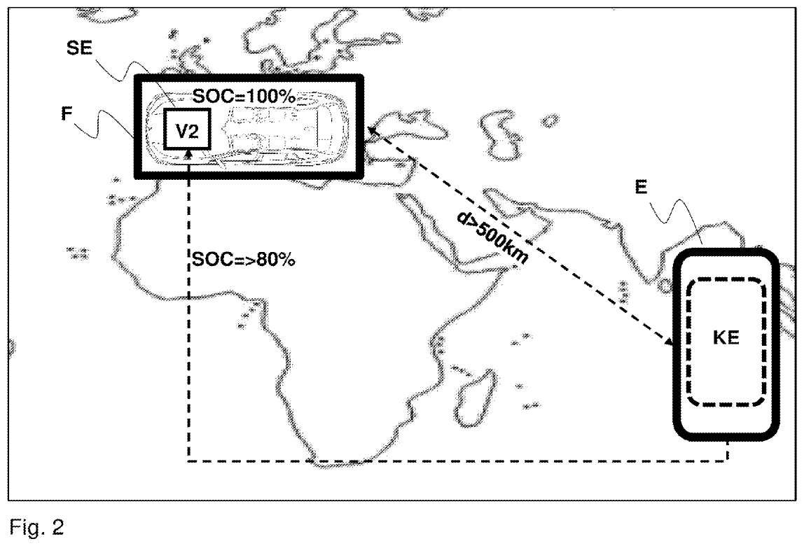

Both FIGS. 1 and 2 illustrate a protective device for a high-voltage battery in an electrified motor vehicle F having a charging connection for charging the high-voltage battery via an energy network which is external to the vehicle, and having an electronic control unit SE which is designed such that, when the motor vehicle F is parked, the control unit monitors and controls the state of charge SOC of the high-voltage battery during charging via the energy network which is external to the vehicle.

In both scenarios, the control unit SE is connected to an on-board function module for locating the motor vehicle F and is wirelessly connected to a mobile terminal E of a user of the vehicle, wherein the terminal E has a function module for locating the user and wherein the control unit SE is configured to receive data of the mobile terminal E. These data represent at least the distance d of the user from the motor vehicle F if this distance is greater than a predefined limit value (for example 500 km).

According to the exemplary embodiment according to FIG. 1, the electronic control unit SE is also configured to send questions (for example “Reduce SOC of the high-voltage battery to 80% for protective purposes?” or “Absence greater than 2 days?”) for the user to the mobile terminal E and to receive answers (for example yes/no) to these questions from the user, wherein the questions relate to the duration for which the motor vehicle F is not intended to be started up and/or to the consent of the user to reduce the state of charge SOC to a defined protective threshold value (for example 80%). The predefined limit value for the distance d is preferably designed to be so great that a longer-distance trip can be deduced therefrom.

According to FIG. 1, the electronic control unit SE is also configured, in a first manually selectable presetting V1, to reduce the state of charge SOC to a defined protective threshold value (80%) only when the consent (“y”) of the user has been confirmed to this effect in the mobile terminal E.

According to the exemplary embodiment according to FIG. 2, the electronic control unit SE is configured, in a second manually selectable presetting V2, to reduce the state of charge SOC to a defined protective threshold value (80%) automatically without further requesting consent when the distance of the user exceeds the predefined limit value (500 km). To this end, a function module KE of the mobile terminal E sends a corresponding instruction to the control unit SE in the motor vehicle F, the control unit being configured to automatically implement this command to reduce the state of charge SOC.

In one development of the disclosure, the electronic control unit SE may also be configured, in a manually selectable presetting, to reduce the state of charge SOC to a defined protective threshold value (80%) automatically without further requesting consent when the distance d of the user or of the terminal E exceeds a first predefined limit value or when the distance d of the user or of the terminal E exceeds a second predefined limit value for a defined period of time, wherein the first limit value is greater than the second limit value.

The inventive “configuration” of the control unit SE is preferably realized by a correspondingly programmed function module in the form of a computer program product (software module).

1.-8. (canceled)

9. A protective device for a high-voltage battery in an electrified motor vehicle, comprising:
a charging connection for charging the high-voltage battery via an energy network which is external to the vehicle; and
an electronic control unit which is configured such that, when the motor vehicle is parked, the electronic control unit monitors and controls a state of charge of the high-voltage battery during charging via the energy network which is external to the vehicle, wherein
the electronic control unit is connected to an on-board function module configured to locate the motor vehicle and is wirelessly connected to a mobile terminal of a user of the vehicle,
the terminal has a function module for locating the user, and
the electronic control unit is configured to receive data of the mobile terminal, which data represent at least a distance of the user from the motor vehicle when this distance is greater than a predefined limit value.

10. The protective device according to claim 9, wherein the electronic control unit is configured to send questions for the user to the mobile terminal and to receive answers to these questions from the user, and the questions relate to the duration for which the motor vehicle is not intended to be started up and/or to the consent of the user to reduce the state of charge to a defined protective threshold value.

11. The protective device according to claim 10, wherein the electronic control unit is configured, in a first manually selectable presetting, to reduce the state of charge to a defined protective threshold value only when a consent of the user has been confirmed to this effect in the mobile terminal.

12. The protective device according to claim 11, wherein the electronic control unit is configured, in a second manually selectable presetting, to reduce the state of charge to a defined protective threshold value automatically, without further requesting the consent when the distance of the user exceeds the predefined limit value.

13. The protective device according to claim 12, wherein the electronic control unit is configured, in a manually selectable presetting, to reduce the state of charge to a defined protective threshold value automatically without further requesting the consent when the distance of the user exceeds a first predefined limit value or when the distance of the user exceeds a second predefined limit value for a defined period of time, and the first limit value is greater than the second limit value.

14. The protective device according to claim 13, wherein a main user and at least one joint user are definable in the electronic control unit, and the decreasing of the state of charge activatable only by the main user, and the joint user is only be informed about the decreasing of the state of charge.

15. The protective device according to claim 14, wherein a main user and at least one joint user are definable in the electronic control unit, and the decreasing of the state of charge is activatable only by the main user, and the electronic control unit has a subfunction which is usable by the joint user to deactivate the decreasing of the state of charge activated by the main user again.

16. A non-transitory computer readable storage medium storing instructions for the electronic control unit and/or for the mobile terminal of the protective device according to claim 15.
